(19) United States
(12) Patent Application Publication
(10) Pub. No.: US 2011/0205169 A1
(43) Pub. Date: Aug. 25, 2011

(54) MULTI-TOUCH INPUT APPARATUS AND ITS INTERFACE METHOD USING HYBRID RESOLUTION BASED TOUCH DATA

(75) Inventor: Taizo Yasutake, Cupertino, CA (US)

(73) Assignee: PRIMAX ELECTRONICS LTD., Taipei (TW)

(21) Appl. No.: 12/952,993

(22) Filed: Nov. 23, 2010

Related U.S. Application Data
(60) Provisional application No. 61/338,754, filed on Feb. 24, 2010.

(51) Int. Cl. G06F 3/041

(52) U.S. Cl. 345/173

(57) ABSTRACT

A method is disclosed for mapping finger movements on a touch pad to a display screen. The method includes receiving touch data from a touch pad. The touch data identifies the absolute coordinates of one or more finger touch points on the touch pad. The method also designates a portion of the display screen as a portion mapping area. The size of the portion mapping area is less than the size of the entire display screen area. The method then maps the coordinates of the one or more finger touch points of the touch data to the coordinates of the portion mapping area. The method includes use of a primary touch pad and a secondary touch pad to generate multi-touch finger gestures.

### CROSS-REFERENCE TO RELATED APPLICATION

This application claims the benefit of prior filed Provisional Application No. 61/338,754, filed Feb. 24, 2010, which application is incorporated by reference.

### FIELD OF THE INVENTION

The present invention relates to methods for mapping finger movements on a touch pad to a computer screen.

### BACKGROUND OF THE INVENTION

Recent development of multi-touch screens for personal computers provide an extended input capability as an additional standard input command for the application programs of computers. Along with the innovation of touch screens, the user-friendly, multi-finger gesture based touch pad also provides considerable improvement for the productivity of software application interface as an alternative input device of the standard input devices such as conventional mice. Currently, some standard input hardware such as a keyboard or a remote controller includes a small-sized, multi-touch sensor pad on its body. However, the small sized multi-touch sensor pad has inherent input difficulties due to its physically small touch area. Using two or three fingers on the surface of small touch pad is not only inconvenient but also potentially problematic by generating unexpected or unwanted input commands due to a highly limited touch detectable area.

Accordingly, substantial need exists for a small-sized, multi-touch digitizer that will have a high precision input capability equivalent to conventional digitizers that may be recognized by the operating system as a standard digitizer, such as a touch pad or tablet.

### SUMMARY OF THE INVENTION

In one aspect, a multi-touch digitizer uses a plurality of touch sensors on a body of an input device to provide a new way of multi-touch user interface, such as a touch pad, for conventional 2D application as well as 3D computer graphics applications.

In another aspect, the hardware and firmware of a small sized digitizer generates multi-touch input commands for application programs that recognize multi-touch messages defined by the operating system. For application programs that do not accept multi-touch messages as a standard input, a user layer interface may be included in the host PC utilizes multi-touch sensor data packet to the interactive commands for application programs.

An advantage of standard digitizers that are designed to follow the interface specifications defined by the operating system is that they do not require installation of a custom designed device driver in the kernel layer of operating system. Once the small-sized, multi-touch digitizer is recognized as a standard digitizer by the operating system, the digitizer can be readily used as an alternative multi-touch input peripheral even though user does not have a multi-touch display screen device.

The aspects described above will become more readily apparent to those ordinarily skilled in the art after reviewing the following detailed description and accompanying drawings, in which:

### BRIEF DESCRIPTION OF THE DRAWINGS

FIG. 1 illustrates a perspective view of computer display with the multi-touch screen.

FIG. 2A illustrates a perspective view of a large multi-touch digitizer.

FIG. 2B illustrates a small sized multi-touch digitizer having a first touch pad and a second touch pad.

FIG. 3A illustrates an absolute mapping mode of a digitizer input.

FIG. 3B illustrates a portion covered mapping mode of a digitizer input.

FIG. 4 illustrates an absolute mapping mode of a digitizer input at a beginning touch.

FIG. 5A illustrates a portion mapping mode of a digitizer input.

FIG. 5B illustrates a portion mapping mode of a digitizer input at beginning touch.

FIG. 5C illustrates a portion mapping mode of a digitizer input during a continuous touching state.

FIG. 6 illustrates how to map touch data of portion mapping mode on a digitizer to an entire area in the screen coordinates by a finger touch on the boundary area of touch pad surface.

FIG. 7 illustrates how to map touch data of portion mapping mode on a digitizer to an entire area in the screen coordinates by a finger touch on the boundary area of touch pad surface.

FIG. 8 illustrates an alternate input method to achieve high precision mapping of touch input to a display screen using portion mapping mode.

FIG. 9 continues the illustration of the alternate input method of FIG. 8.

FIG. 10 continues the illustration of the alternate input method of FIGS. 8-9.

FIG. 11 continues the illustration of the alternate input method of FIGS. 8-10.

FIG. 12 continues the illustration of the alternate input method of FIGS. 8-11.

FIGS. 13A-G illustrate two-finger touch gestures and the mapping of those touch data to PC screen coordinates.

FIG. 14 illustrates a two-finger pinch-stretch gesture on digitizer using secondary touch pad.

FIG. 15 illustrates a two-finger rotation gesture on digitizer using secondary touch pad.

FIGS. 16A-B illustrate a two-finger translation gesture on digitizer using secondary touch pad.

FIG. 17 illustrates a flowchart of a method for recognizing finger gestures using a primary and secondary touch pads.

FIGS. 18A-B illustrate finger gesture of a stretch and pinch gesture, respectively.

FIG. 19 illustrates a graphical representation for calculating the trajectory angle θ from two consecutive touch points.

FIG. 20 illustrates a two-finger gesture having a circular motion that generates rotation command.

FIGS. 21A-21D illustrate directions of rotation for a rotation command.

FIGS. 22A-22B illustrate function block diagrams of interface software between a digitizer and an operating system in a personal computer.

### DETAILED DESCRIPTION OF THE PREFERRED EMBODIMENT

### 1. Multi-Touch Digitizer and Control Command Generation

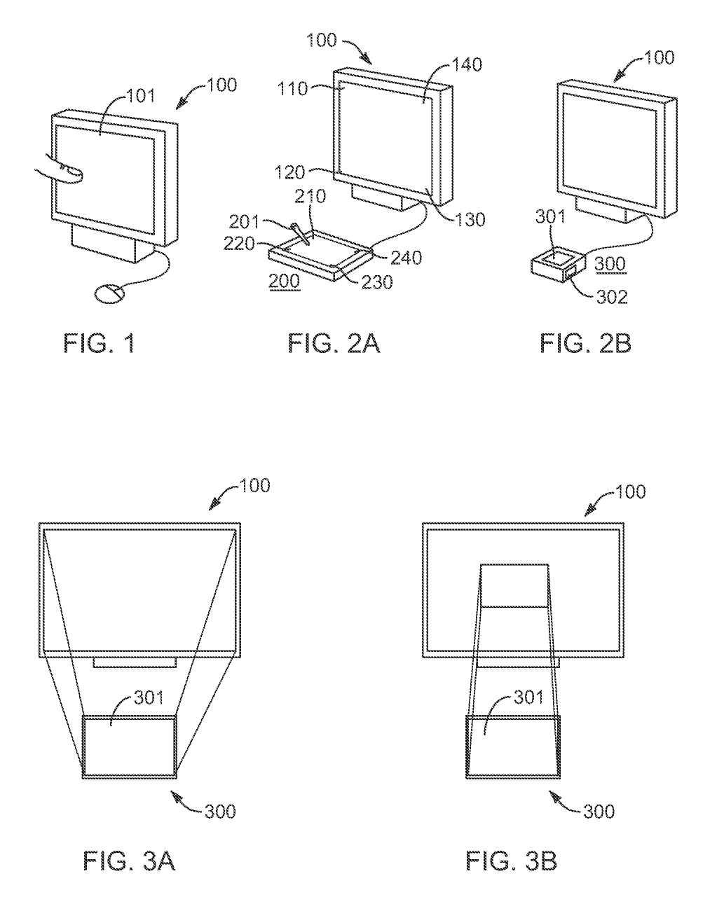

FIG. 1 depicts a personal computer with a multi-touch screen 100. A user can generate input commands by touching the surface 101 of display monitor with one or more fingers.

FIG. 2A depicts a multi-touch digitizer tablet 200 for a computer system. The digitizer tablet 200 may utilize an input stylus 201 to create input touches on the surface of the digitizer pad. The digitizer creates an absolute input or one-for-one correspondence between the coordinates of the touch location on the surface of the digitizer pad and the display screen coordinates. For example, the multi-touch digitizer tablet 200 has four corners 210, 220, 230, and 240 that correspond to the four corners of the display monitor, 110, 120, 130, and 140 respectively. This differs from a traditional input mouse, in which all mouse movements are relative to the current cursor position on the screen, because the raw data from mouse is defined by the change of distance (delta X and delta Y) or the change of mouse movement.

FIG. 2B depicts a digitizer 300 similar to that shown in FIG. 2A, but the size of touch pad 301 is smaller than that in FIG. 2A. The mini-digitizer in FIG. 2B is also equipped with another small touch pad 302 that only detects a single touch. In other embodiments the two touch pads are disposed on the same plane rather than being disposed on separate planes, as shown.

One of the disadvantages of a small sized digitizer is that it is difficult to achieve high precision mapping of a touch point in local coordinates of a touch pad to the display screen coordinates due to the size limitation of the touch pad area. Additionally, it may be difficult to accurately map touches on small sized touch pads to large display screens.

FIGS. 3A and 3B illustrate two different mapping modes that may be used to map touches on a touch pad to a display screen. As shown in FIG. 3A, in some instances, the digitizer firmware provides an entire mapping mode, wherein the absolute touch position data of the touch pad is mapped to the entire display screen. In other embodiments, the digitizer firmware provides a portion mapping mode, such as that illustrated in FIG. 3B, wherein the absolute touch position data of touch pad is mapped to a portion mapping area of the display screen.

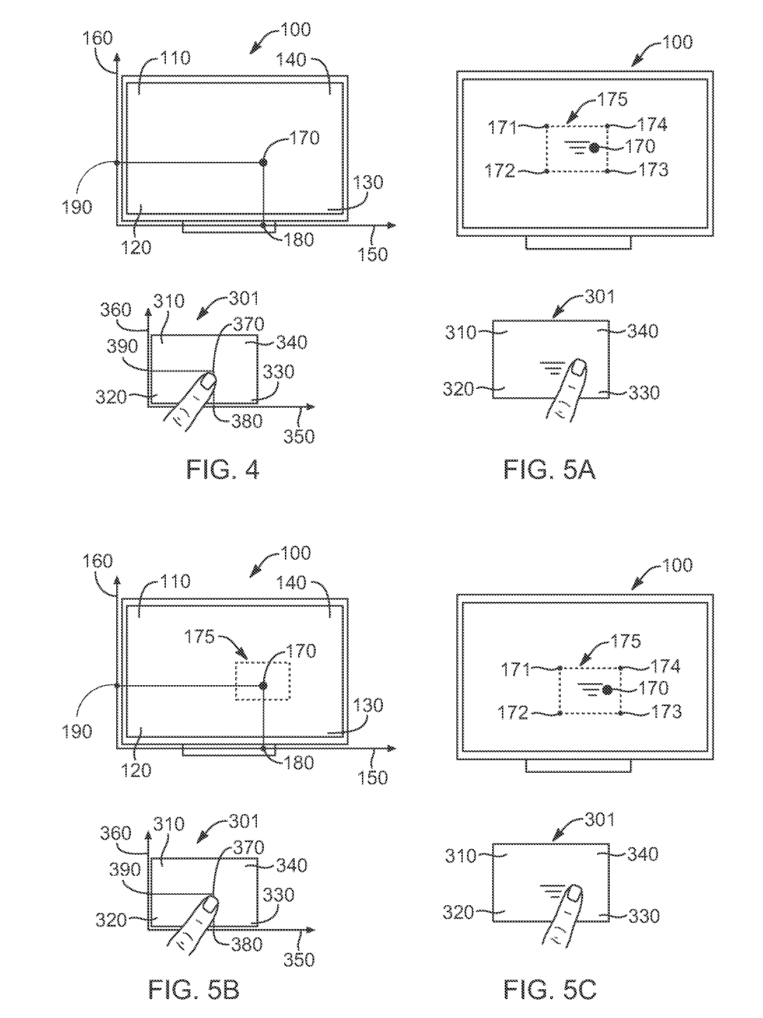

FIG. 4 depicts the entire mapping mode in detail. The set of horizontal axis 350 and vertical axis 360 consists of the local two dimensional coordinates on the surface of touch pad 301. The set of horizontal axis 150 and vertical axis 160 consists of the display screen coordinates on the surface of the display screen.

The absolute position data at upper left corner 310 on the touch pad is mapped to the absolute location at upper left corner 110 on the display screen coordinates. The absolute position at lower left corner 320 on the touch pad is mapped to the absolute location at lower left corner 120 on the display screen coordinates. The absolute position at lower right corner 330 on the touch pad is mapped to the absolute location at lower right corner 130 on the display screen coordinates. The absolute position at upper right corner 340 on touch pad is mapped to the absolute locations at upper right corner 140 on the display screen coordinates.

The finger touch point 370 on the touch pad is reported as raw data that identifies the local X position 380 and local Y position 390 of a touch. This touch data is mapped to the display screen point 170 or screen X position 180 and screen Y position 190 in the screen coordinates. In some embodiments, the resolution of touch pad data in the entire mapping mode is proportional to the size of touch pad when all other engineering capability and/or specifications of touch pad are not changed. Accordingly, larger touch pads may have higher input resolutions.

FIG. 5A depicts the portion mapping mode. In portion mapping mode, the center point of the touch pad is specified by the middle points of local X coordinates and local Y coordinates on the touch pad surface. This center point is mapped to the center point of the portion area on the display screen coordinates. The boundary points 171, 172, 173 and 174 of the portion mapping area are specified. In portion mapping mode, the local coordinates of the touch pad 301 are mapped to coordinates within this portion mapping area.

Accordingly, the absolute position data at upper left corner 310 on touch pad is mapped to the absolute location at upper left corner 171 on the portion area display screen coordinates. The absolute position at lower left corner 320 on touch pad touch pad is mapped to the absolute location at lower left corner 172 on the portion area display screen coordinates. The absolute position at lower right corner 330 on touch pad is mapped to the absolute location at lower right corner 173 on the portion area display screen coordinates. The absolute position at upper right corner 340 on touch pad are mapped to the absolute locations at upper right corner 174 on the portion area display screen coordinates.

In some embodiments, the touch pad data sent to the PC are a sequence of coordinates that represent absolute touch points on the surface of the touch pad. In some embodiments, these data packets are then mapped to the absolute coordinates of the PC screen. This is a big difference from 2D mouse mode (reporting of relative position data or the change of absolute position of touch) usually available by a conventional digitizer.

As will be understood from the foregoing discussion, the portion mapping mode may realize higher precision touch data than the entire mapping mode.

### 2. Hybrid Mapping Method

In some embodiments, to achieve high precision touch data using a small sized touch pad, input generation is dependent on finger touch states. Thus, in some embodiments, firmware corresponding to the touch pad is programmed to recognize multiple touch states, during a single touch of the touch pad, such as the following three states:

State 1. At beginning of finger touch on the surface of pad;

State 2. Continuous touch action within the edge region of touch pad surface; and

State 3. Continuous touch entering the edge region of touch pad surface.

### Establishment of Initial Touch Point.

FIGS. 4-7 depict a hybrid mapping mode that uses both the first and second mapping modes. In one embodiment, initially, entire mapping mode is used when a finger touches the pad. When the finger remains in contact with the pad, and the touch continues, the mode switches to portion mapping mode.

The establishment of an initial touch point with high precision on PC screen coordinates is required for some application software. The transition from entire mapping mode to portion mapping mode can be initiated by one or more of the following programmable methods: (i) pre-defined time window; (ii) amount of finger pressure or finger touch area; (iii) usage of a secondary touch pad.

The first method for switching from entire mapping mode to portion mapping mode is initiated when a user touches and holds the touchpad for pre-defined time. For example, if user initially touches the surface of touch pad and holds the finger on the touch pad for one second the firmware changes the mapping mode from entire mapping mode to the portion mapping mode. In other embodiments, this time period is two seconds, three seconds, or up to ten seconds.

The second method uses the threshold value of finger pressure or finger touch area to change modes. For example, if user presses harder on the touch pad and its pressure exceeds the pre-defined value, then the entire mapping mode switches to portion mapping mode.

In the third method, entire mapping mode is switched to portion mapping mode change when a user touches a secondary touch pad or a triggers a digital switch, such as a button.

In hybrid mapping mode, depicted in FIGS. 5-7, the initial touch point on the touch pad is mapped onto the display screen using entire mapping mode. The entire mapping mode at the beginning of touch provides “moderate” or “low” resolution on the display screen. Some multi-touch input ready applications require an initial touch point on a display screen with very high precision. In this case, the entire mapping at the beginning in FIG. 5B is not adequate to provide high precision pointing by initial touch if the size of the touch pad is small.

In order to overcome the above disadvantage, an alternate hybrid mapping mode may be used to improve the precision of pointing on the display screen by an initial touch on touch pad. The basic idea for the improvement of touch resolution at the beginning of touch action is to adopt portion covered mapping mode from the beginning of the touch using the firmware algorithm including two computational steps described below.

The first step is to determine a temporal initial touch point 170 in the display screen coordinates when the user touches both the multi-touch pad 301 and a side pad 302 shown in FIG. 8. The firmware acknowledges the initial touch on the pad 301 is used for a temporal touch point by detecting another finger touch on side pad 302. In some embodiments, the utility application program visualizes a temporal touch point 170 by changing the cursor icon on the display screen. For example, by rendering a small 2D triangle shaped graphic object 186, or other shaped graphical object, on the display screen so that the triangle object 186 is shown the identical position of touch point on the display screen shown in FIG. 8.

The temporal touch point can be moved by sliding the finger touch point 370 on the surface of the touch pad 301 with a simultaneous touch on the side pad 302 by another finger, as shown in FIG. 9. If the initial touch is not a desired touch point on the display screen, the user can slide his/her fingers to change the touch point under the portion mapping method by firmware until the touch point reaches the desired location. The temporal initial touch point is not sent as a touch data by the firmware to the kernel device driver for digitizer in the operating system.

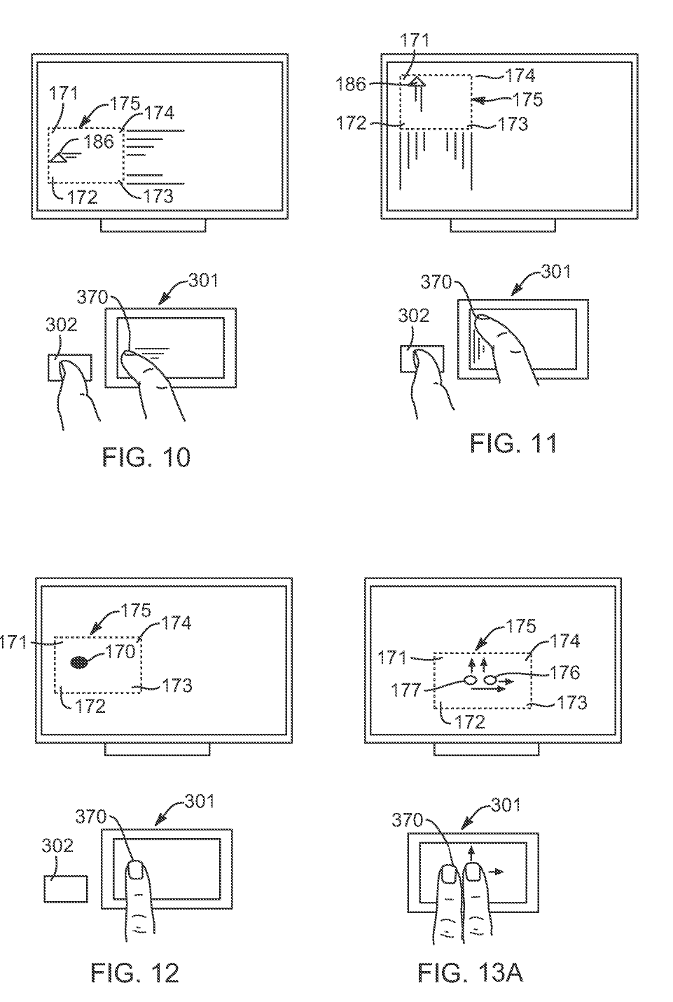

FIGS. 10 and 11 depict to the process of moving the temporal initial touch point using a continuous translation command by moving the triangle 186 to the edge region of the portion mapping area 175. Once user decides to fix the initial touch point, he/she can release the finger from the side pad 302. FIG. 12 depicts the establishment of the position of an initial touch. This absolute position data is sent as an initial touch point by the firmware of the touch pad to the kernel driver for the digitizer. A supplemental utility application program can change the shape and color of the graphic object representing the cursor from, for example, a small triangle shape (transition point) to small circle with red color (establishment of initial touch point) by visual feedback.

### Translation of the Portion Mapping Area Using Touch Data on Edge Region of Touch Pad

FIG. 5B depicts State 2, the continuous touch action within the portion mapping area. During this state, the firmware acquires an absolute position data of touch in local coordinates 350 and 360 and maps these coordinates to an absolute position 170 in the display screen coordinates 150 and 160. The initial touch point 370 is used to specify the initial location of the portion mapping area 175 including four corner locations 171, 172, 173, 174. While the touch point on the surface of touch pad is within the edge region or State 2, the absolute position data of the touch point is mapped in the screen area 175 shown in FIG. 5C.

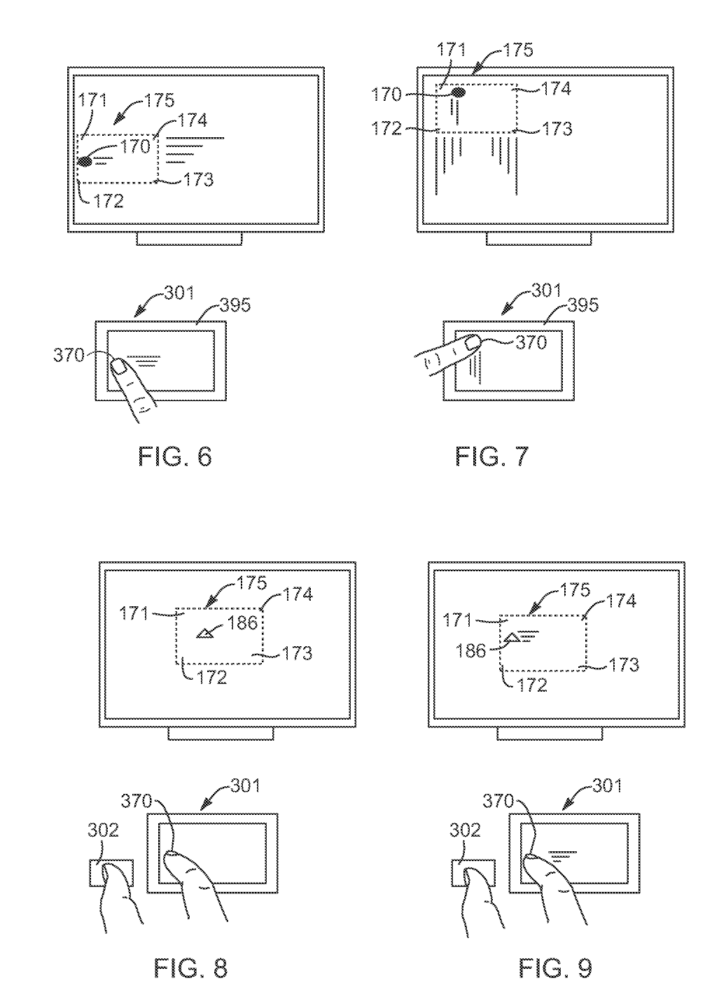

When the touch point on the touch pad reaches the edge region 395 of touch pad surface (FIGS. 6 and 7), the firmware enters State 3 and responds by continuously updates and moves the location of portion mapping area in the direction of the touch point. This enables the firmware to generate continuous movement of touch point on the display screen.

FIGS. 6-7 depict the finger touch reaching to the edge region 395. The edge region 395 is an area directly adjacent the edge of the touch pad. In some embodiments, the edge region has dimensions of approximately 1-10% the overall length of the touchpad. The firmware recalculates the portion mapping area 175 using the last position change of the touch data at iteration cycle as a translation velocity of the movement command for area 175 and the finger touch point 170 in the display screen. By the updating of locations for both mapping area 175 and touch point 170, the user can keep on generating a continuous translation command of touch point even after his/her finger reaches the edge region 395 of the touch pad. In FIG. 6, the user's finger reaches the left boundary area on the touch pad. However, the user can continuously move the touch point 170 in a left horizontal direction on the display screen by holding the finger in place. In FIG. 7, the user's finger reaches the upper boundary area on the touch pad. However, the user can continuously move the touch point 170 in a vertical direction on the display screen by holding the finger in place.

### 3. Multi-Touch Finger Gesture Generation by Hybrid Resolution Based a Multi-Touch Pad

In some embodiments, when two or more fingers touch the touch pad simultaneously, the two or more corresponding touch points generate a multi-touch gesture.

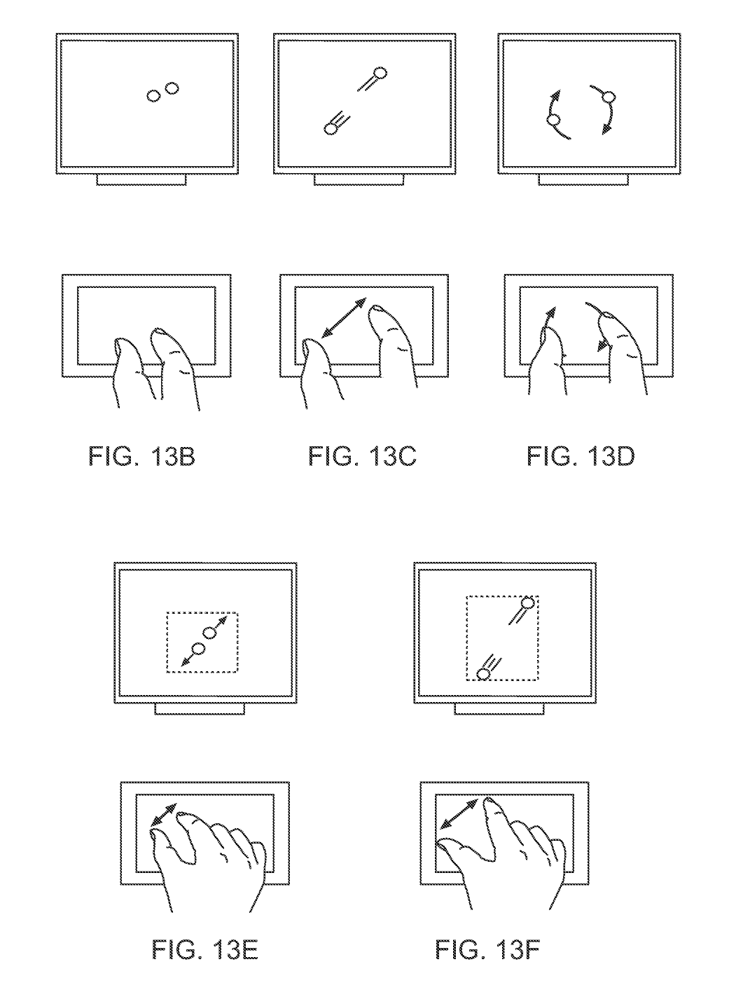

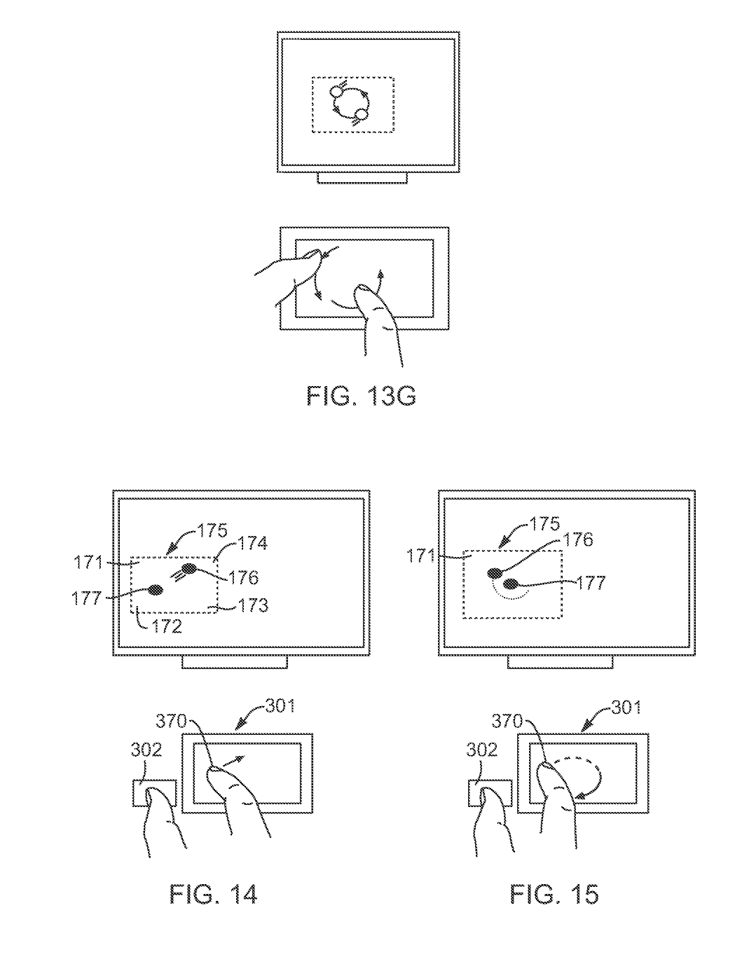

FIG. 13A depicts two touch points 176 and 177 on the surface of touch pad 301, which are mapped to the region 175 in the display screen coordinates. When moved, the two touch points generate a translation gesture. Various translation gestures are depicted in FIGS. 8-11 and 13A-G. FIG. 13C depicts two touch points 176 and 177 on the surface of touch pad that are mapped to the display screen coordinates. As illustrated, in FIG. 13C, the user moves his/her fingers in a stretch/pinch gesture. FIG. 13D depicts two touch points on the surface of touch pad are mapped the display screen coordinates, then generate circular trajectory gesture.

### The Finger Gesture and the Size and Location Change of Portion Mapping Area

Finger translation gesture allows the movement of the portion mapping area using a finger touch point on the edge region on the surface of touch pad. As a default, any other finger gestures are confined and generated within a latest location of the portion mapping area. In some embodiments, a user can modify the size of the portion mapping area using the touch on an edge region. For example, in FIG. 13E and FIG. 13F, the stretch gesture allows the expansion of portion mapping area if one or both fingers reach the edge region of the touch pad.

### Continuation of Finger Gesture Generation

Continuation of translation gesture. Using the finger touch on the edge region of the touch pad, the firmware can continue the translation gesture. This means that the portion mapping area also changes location to follow the continuous translation shown in FIGS. 5C, 6 and 7.

Continuation of stretch gesture. In order to realize the continuous stretch gesture, a pair of finger touch points linearly move apart. Under this condition, if both finger mapping points on the PC screen do not reach to the boundary region of the PC screen display area and one of the fingers on the touch pad reaches the edge region of the portion mapping area, then the firmware can continue the stretch gesture. In FIGS. 13E and 13F, the stretch gesture will continue if one or both fingers reach the edge region of the touch pad

Continuation of circular trajectory gesture. In order to realize the continuous circular gesture, a pair of finger touch points initiates a circular trajectory gesture. Under this condition, if both finger mapping points on PC screen do not reach to the boundary region of the PC screen display area and one of the fingers on the touch pad reaches the edge region of the portion mapping area, then the firmware can continue the circular trajectory gesture. In FIG. 13G, the circular trajectory gesture will continue if one or both fingers reaches the edge region of the touch pad.

4. Matching of Resolution Mode between PC Screen Display Mode and Assumed PC Display Mode stored by Firmware

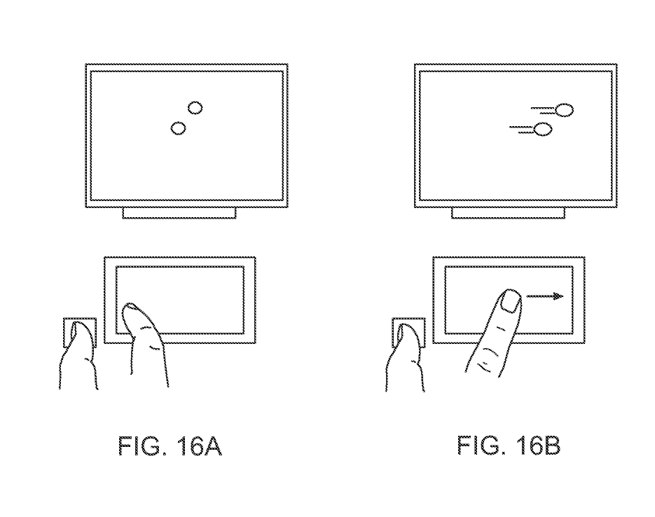

In some embodiments, the firmware stores the data set for the host PC screen display resolution mode (i.e. 800×640 pixel mode), depending on the resolution of the PC screen display. However, in some instances, the user might change his/her PC screen display mode for some reasons. In order to maintain correct mapping of the touch pad data packet to the currently selected PC screen display mode, the firmware needs to receive the mode change information from the host PC side when a user changes to a new display mode. Accordingly, in some embodiments, the user level monitoring software continuously or periodically checks the current screen display resolution mode and sends a new display mode data to the firmware when a user changes to a new resolution mode. FIGS. 16A and 16B depict the functional block diagram including the program that continuously monitors the current PC display resolution mode.

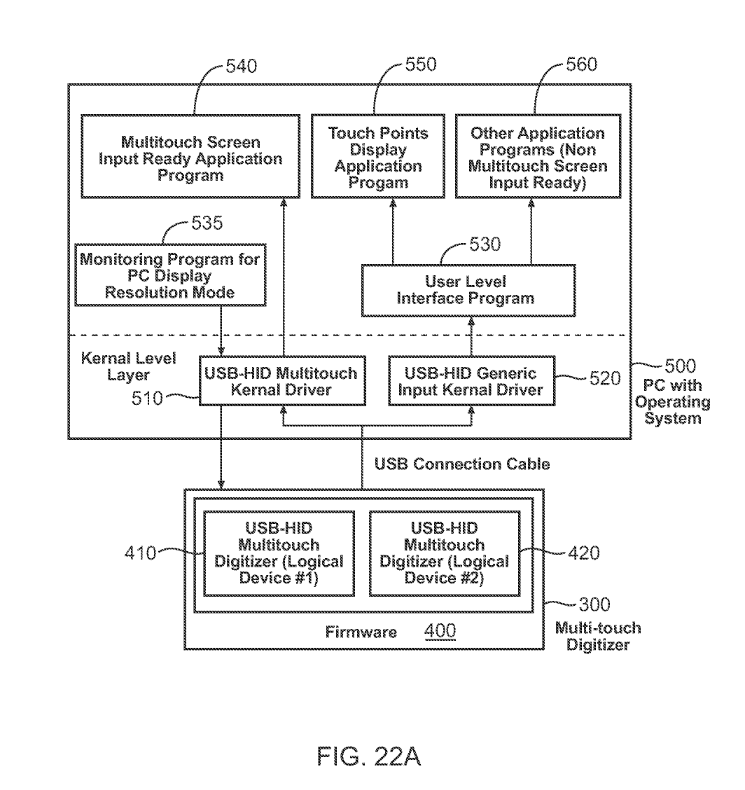

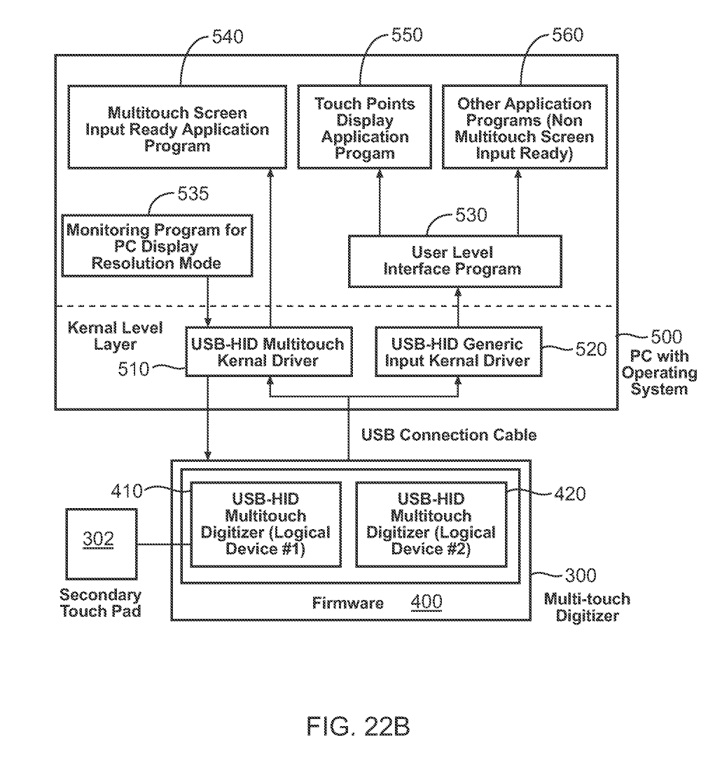

In FIG. 22A, a monitoring program 535 of the operating system of a host PC continuously or periodically checks for changes in the PC display resolution mode. When a change is detected, the monitoring program 535 sends the latest display mode of the PC screen to the firmware 400 of the touch pad. In some embodiments, the touch pad is coupled to the PC via a USB connection, wireless connection, Bluetooth connection, or other like connection.

5. Multi-Touch Gesture Generation by Hybrid Resolution Based Small Sized Multi-Touch Sensor Pad with Secondary Touch Pad (Touch/Non-Touch Status) or Digital Switch

In some circumstances, it may not be easy for some users to execute multi-finger gestures such as a circle trajectory or stretch-pinch gesture on the surface of a small touch pad. When a small sized multi-touch pad is used, a single touch data on the surface of both the small multi-touch pad 301 and secondary touch pad 302 could be used to generate a virtual second touch point to emulate a two finger gesture for mapping to the display screen.

FIG. 16B depicts how the firmware can, in some embodiments, map a multi-finger gesture using two separate touch pads 301 and 302. As shown, the touch position 370 on the multi-touch pad is mapped to the first touch point 176 in the display screen by the portion covered mapping mode. The firmware also generated and mapped the finger touch data on the secondary pad to be an emulated or virtual second touch point 177 in the display screen coordinates. With fingers on each of the two touch pads, the user can generate multi-finger gestures that might otherwise be difficult to make on a single touch pad alone. When the user slides his/her single finger on the primary touch surface of 301 in a linearly horizontal or vertical direction, the corresponding first touch point 176 and the second touch point 177 are generated as a translation gesture by the firmware. The relative distance between the first touch point and second touch point can be programmable by the firmware.

FIG. 14 depicts how, in some embodiments, the firmware maps the finger touch position 370 on the multi-touch pad to the first touch point 176 in the display screen by the portion covered mapping mode. The firmware also maps the finger touch data on the secondary pad to be an emulated or virtual second touch point 177 as a fixed touch point in the display screen coordinates that is located within the portion mapping area 175. The pre-defined location of the fixed touch point 177 can be modified by the firmware. When a user slides his/her single finger on the surface of the touch pad 301 in a diagonal direction, the corresponding touch point 176 on the display screen and the fixed second touch point 177 are recognized as a stretch-pinch gesture by two fingers.

Using this emulated, second touch data created by the firmware, the user does not have to use two fingers on the small surface area of multi-touch pad 301. The user can effectively drag a single finger on the touch pad, rather than sliding two fingers on the same surface area 301.

FIG. 15 depicts another mapping method by the firmware to emulate a two finger gesture based circular trajectory gesture generation. In FIG. 15, the firmware mapped the finger touch position 370 on the multi-touch pad to the touch point 176 as the first touch point in the display screen by the portion mapping mode. The firmware also maps the finger touch data on the secondary pad to the touch point 177 as a fixed second touch point in the display screen coordinates that is located within the portion mapping area 175. The pre-defined location of the fixed touch point 177 can be modified by the firmware. When user drags a circle with his/her single finger on the surface of 301, the corresponding touch point 176 on the display screen and the fixed second touch point 177 can be acknowledged as a circular trajectory gesture by two fingers and the touch point 177 is recognized as a pivot.

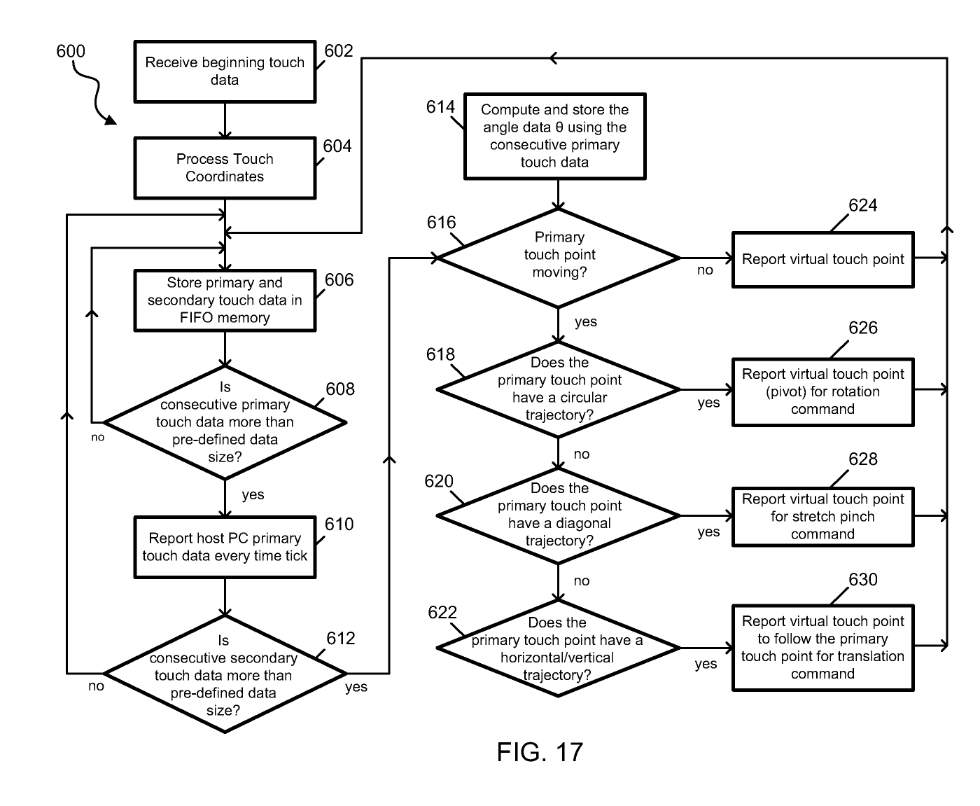

FIGS. 17-21D depict methods and steps for recognizing the movement of touch points on a touch pad. FIG. 17 depicts a flowchart that charts a method 600 that firmware associated with a primary touch pad and a secondary touch pad may use, according to some embodiments, that recognizes the movement of touch points and reports multi-finger touch commands when specific touch gestures are recognized. This method determines the movement of touch points based on stored touch data. In some embodiments, touch data is stored in FIFO (first in first out) memory in firmware. The memory stores sufficient touch points to recognize movement of the touch points over time, during a finger gesture.

The method 600 begins when a touch is recognized 602 on a touch pad. When a touch is recognized, the touch point coordinates are processed 604. If both a primary touch and a secondary touch are activated by fingers, then the firmware generates the second touch point as a virtual touch. In some embodiments, the touch point coordinates are processed at each pre-determined time interval. The raw data from consecutive touches on the primary and secondary touch pads are stored in memory 606, such as FIFO memory. It is then determined whether the touch data from the consecutive touches are greater than a pre-defined data size 608. In some embodiments, this determination may assure that sufficient touch data are available for recognizing finger gestures and/or this determination assures that quick accidental or incidental touches are not recognized. Once it is determined that the size of the touch data exceeds the pre-defined data size 608, the touch data for the primary touch pad are reported to the host PC periodically 610, such as at every time click of a clock. Accordingly, if the input touch command consists only of a single touch, the single touch is sent to the host PC without other data.

However, the method 600 is adapted for instances in which touch data includes a touch on a secondary touch pad 612. In such instances, the method determines whether a consecutive secondary touch data is greater than a pre-defined data size 612. If such is the case, the method 600 computes a virtual touch point, in steps 614-630. When both the primary touch pad and the secondary touch pad are activated, the firmware generates the second touch point as a virtual touch. The generation of the second tough point, or the virtual touch point, is based on the direction of the primary touch point. Accordingly, depending on direction of the primary touch point, the pair of two touch point data packets can be utilized to create a gesture, such as a translation gesture, a stretch/pinch gesture, or a circular motion gesture (rotation gesture).

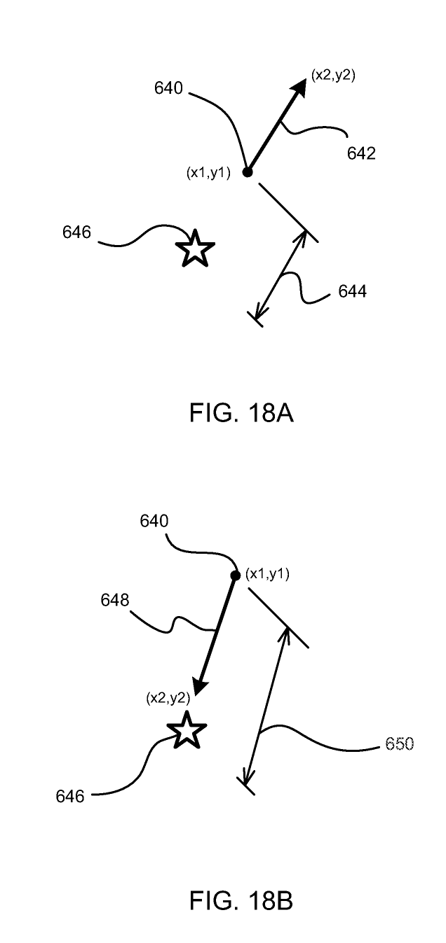

This process initiates by computing and storing (such as in FIFO memory) the angle data of the consecutive primary touch. Non-limiting examples of such computations are illustrated in FIGS. 18A-21D, and described below. Referring again to the method of FIG. 17, if the method determines that the primary touch point is moving 616. If the primary touch point is not moving, then the virtual touch point is reported 624. If the method determines that the first touch point has a circular trajectory 618, then it reports the virtual touch point as a pivot for a rotation command 626. If the method determines that the primary touch point has a diagonal direction 620, then it reports the virtual touch point as a stretch/pinch command 628. If the method determines that the primary touch point has a horizontal or vertical direction 622, then it reports the virtual touch point as a point that follows the primary touch point in a translation command 630. Accordingly, the method 600 interprets a user created touch trajectory among four possible gesture patterns: a single touch on primary touch pad (arbitrary movement), a two finger touch translation (horizontal/vertical dominant movement), a two finger touch stretch/pinch (diagonal movement), a rotation gesture (circular movement).

FIGS. 18A-18B depict the creation of a virtual touch point when the system recognizes the primary touch point 640 moving to create a stretch or pinch gesture. As shown in FIG. 18A, a stretch gesture is identified when the primary finger touch trajectory 642 shows linear movement in a positive diagonal direction. This is recognized when the trigonometric function ArcTan((y2−y1)/(x2−x1)) is positive, the angle is close to 45 degrees, and the secondary touch pad is ON (touched by user's finger). As used herein, an angle θ is “close to” a specific measure if it is within a predefined angle deviation value of the angle. In some cases, the predefined angle deviation value may be about 10 degrees of the measure, i.e. ±10 degrees. In some cases, the predefined angle deviation value may be within 5 degrees, i.e. ±5 degrees of a specific measure. Persons having ordinary skill in the art will appreciate that the specific tolerance within a specific angle measure may be varied to accomplish the practical purposes of the invention. When these conditions are met, the firmware generates the virtual touch point 646 that it is placed a fixed location on the line of primary touch trajectory and its predefined distance 644 from initial location (x1, y1) 640 of primary touch is shorter than any other consecutive primary touch points in FIFO.

As shown in FIG. 18B, a pinch gesture is identified when the primary finger touch trajectory 648 shows linear movement in a negative diagonal direction. This is recognized when the trigonometric function ArcTan((y2−y1)/(x2−x1)) is negative, its angle is close to −135 degrees, and the secondary touch pad is ON (touched by the user's finger). When these conditions are met, then the firmware generates the virtual touch point 646 that it is placed a fixed location on the line of primary touch trajectory and its predefined distance 650 from initial location (x1, y1) of primary touch 640 is longer than any other consecutive primary touch points in FIFO.

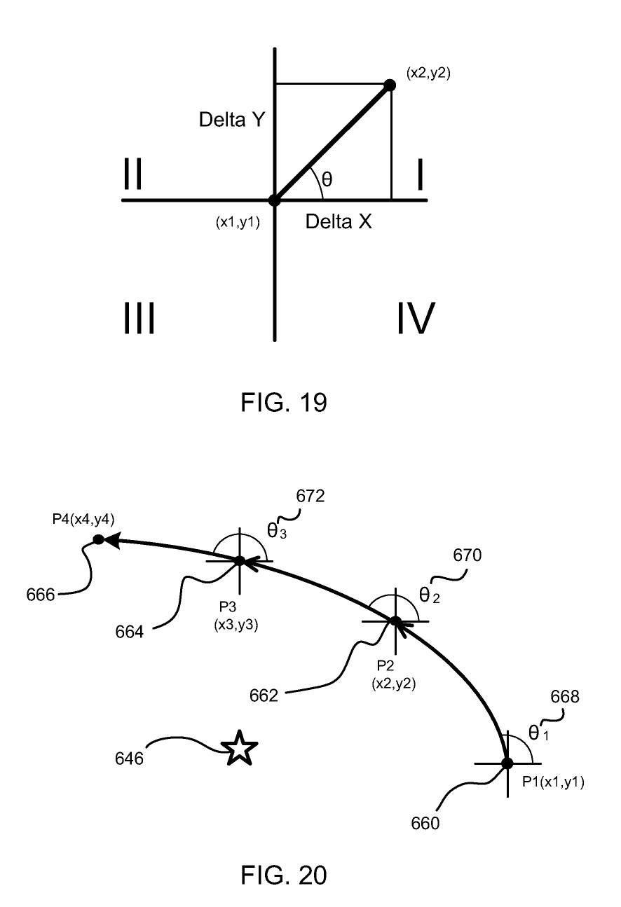

FIG. 19 illustrates a graphical representation for calculating the angle (theta) 0 of touch point movement, which is used in the method of FIG. 17. This figure depicts a two coordinate system having an X-axis and a Y-axis. These axes create four quadrants (labeled I, II, III, and IV). The first point on a touch pad is depicted at the coordinates (x1, y1) and a second, consecutive point (on the touch pad) is depicted at coordinates (x2, y2). An angle, θ, is depicted between the X-axis and a line between the first point and the second point (x2, y2). The angle θ can be obtained from ArcTan ((y2−y1)/(x2−x1)).

FIG. 20 depicts a two finger gesture having a circular motion that generates rotation command (pivot based rotation). This gesture includes four consecutive touch points: P1 (x1,y1) 660, P2 (x2, y2) 662, P3 (x3, y3) 664, P4 (x4, y4) 666. The firmware stores the consecutive touch data P1, P2, P3, and P4 and computes the angle θ for each touch point using consecutive pairs of consecutive touch points. For example, θ₁=ArcTan((y2−y1)/(x2−x1)), θ₂=ArcTan((y3−y2)/(x3−x2)), θ₃=ArcTan((y4−y3)/(x4−x3)) and so on. When the rotation command gesture is recognized, the firmware computes a virtual touch point 646.

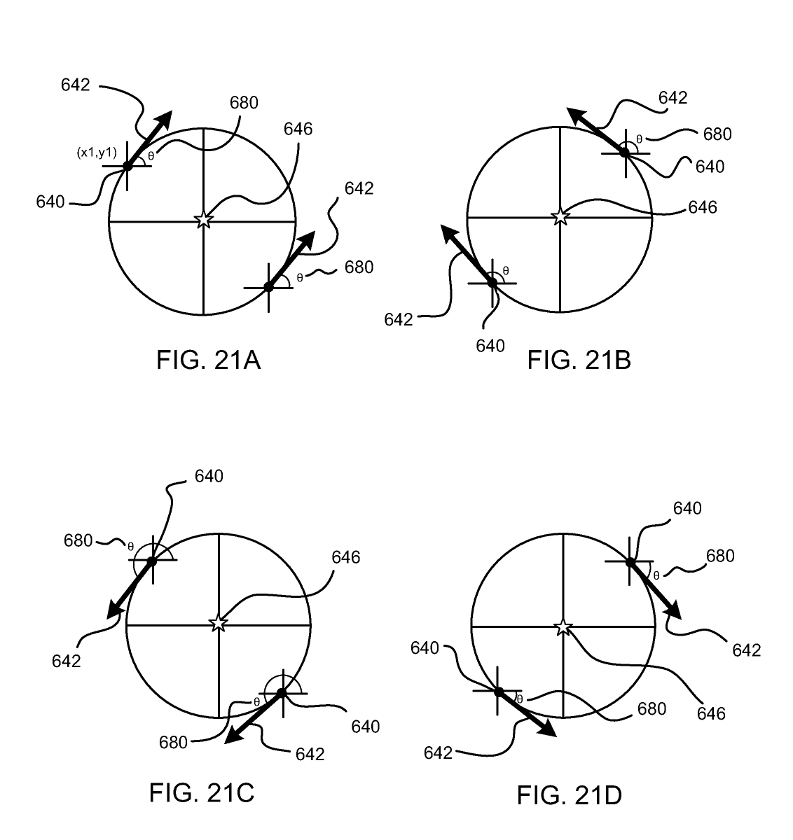

FIGS. 21A-21D show how to interpret the direction of rotation in order to generate a rotation command. The directions of rotation include clockwise (CW) and counter clockwise (CCW). These directions are identified using the angle θ and the primary touch data and pre-defined location of the virtual pivot point.

The direction or rotation is determined based on the deltaX, deltaY, and the change in θ 680. For instance, as illustrated in FIG. 21A, if deltaX>0, deltaY>0 and the θ's are increasing, then the primary touch trajectory 642 of the primary touch point 640 is interpreted as CCW. The virtual pivot point 646 is pre-defined location in quadrant IV that meets Px<x1 and Py>y1. Additionally, if deltaX>0, deltaY>0 and the θ's 680 are decreasing, then the primary touch trajectory is interpreted as CW. The virtual pivot point, P (Px, Py), 646 is pre-defined location in quadrant II that meets the condition of Px>x1 and Py<y1.

As illustrated in FIG. 21B, if deltaX<0, deltaY>0 and the θ's 680 are increasing, then the primary touch trajectory 642 of the primary touch point 640 is interpreted as CCW. The virtual pivot point P 646 is pre-defined location in quadrant I that meets Px<x1 and Py<y1. Additionally, if deltaX<0, deltaY>0 and the θ's are decreasing, then the primary touch trajectory 642 is interpreted as CW. The virtual pivot point P 646 is pre-defined location in quadrant III that meets Px>x1 and Py>y1.

As illustrated in FIG. 21C, if deltaX<0, deltaY<0 and the θ's 680 are increasing, then the primary touch trajectory 642 of the primary touch point 640 is interpreted as CCW. The virtual pivot point P 646 is pre-defined location in quadrant II that meets Px>x1 and Py<y1. Additionally, if deltaX<0, deltaY<0 and the θ's 680 are decreasing, then the primary touch trajectory 642 is interpreted as CW. The virtual pivot point P 646 is pre-defined location in quadrant IV that meets Px<x1 and Py>y1.

As illustrated in FIG. 21D, if deltaX>0, deltaY<0 and the θ's 680 are increasing, then the primary touch trajectory 642 of the primary touch point 640 is interpreted as CCW. The virtual pivot point P 646 is pre-defined location in quadrant III that meets Px>x1 and Py>y1. Additionally, if deltaX>0, deltaY<0 and the θ's are decreasing, then the primary touch trajectory 642 is interpreted as CW. The virtual pivot point P is pre-defined location in quadrant I that meets Px<x1 and Py<y1.

### 6. Multi-Touch Gesture Generation by Two Single Touch Sensor Pad

If the user requirement of finger gesture generation is up to two fingers, then the multi-touch pad can be replaced with a single touch detection sensor. FIG. 16A depicts the set of a single touch sensor pad 301 as a primary touch pad and secondary touch pad 302 that only reports touch/non-touch status (the touch status). The secondary touch pad can be a digital switch, because the On/Off status signal is used to add the number of finger touches.

The two finger based gesture generation, stretch/pinch, circular trajectory, translation gesture depicted in FIGS. 14, 15, and 16B respectively can be realized by the set of a single touch pad for the primary touch pad and a secondary touch pad.

### 7. Device Driver Program on Host PC

FIGS. 22A and 22B depict the function block diagram of basic software modules and firmware 400 of multi-touch digitizer 300. The multi-touch digitizer contains the multi-touch sensor pad 301 and a secondary touch pad 302 in FIG. 22B.

The firmware 400 acquires the raw data of finger touch activities from both touch pads as original data and modifies those data to fit the data packets that are recognized as a standard USB-HID multi-touch digitizer and/or generic USB-HID input device by the operating system in personal computer 500.

In some embodiments, the firmware logically defines two independent USB devices or the first logical device 410 and the second logical device 420. The first logical device 410 defines the multi-touch pad 301 is a standard multi-touch digitizer to report pre-defined digitizer data packet to host PC through USB connection. The second logical device 420 defines a generic USB-HID input device to report pre-defined HID data packet to host PC through USB connection.

In some embodiments, the device driver module 510 for the multi-touch digitizer acquires raw data of the first logical device and the device driver module 520 for generic HID input device will acquire raw data of the second logical device. The connection and data transfer protocol between the input device and the computer can be implemented by the USB connection defined by USB organization. The operating system, such as Windows operating system, in the PC 500 provides a built-in kernel mode driver for acquisition of USB data packets. Application programs 540 recognize multi-touch messages as standard interactive input commands and receive the commands from device driver module 510.

The interface module 530 in user mode layer of the operating system acquires raw data packets of the second logical device 420. Using acquired data, the supplemental application module 550 displays the location of touch point(s) by rendering graphical object(s) on the display screen. Also, the acquired data could be used to generate input commands for the application programs 560 which are commercially available, but do not recognize multi-touch messages as standard interactive input commands.

The multi-touch sensor pad can be extended as a multi-function pad such as a USB-HID composite input device consisting of conventional 2D mouse mode, digitizer mode, and generic HID mode (vendor specific mode). In this case, the firmware adds logical device #3 as device definition of 2D mouse (data reporting of mouse cursor position, L/R mouse button status).

While the invention has been described in terms of some particular embodiments, it is to be understood that the invention needs not be limited to the disclosed embodiment. On the contrary, it is intended to cover various modifications and similar arrangements included within the spirit and scope of the appended claims.

What is claimed is:

1. A method for mapping finger movements on a touch pad to a display screen, the method comprising:
receiving touch data from a touch pad, the touch data identifying the absolute coordinates of one or more finger touch points on the touch pad;
providing one or more mapping modes for mapping the absolute coordinates of the one or more finger touch points to the display screen, wherein one mapping mode comprises a portion mapping mode and wherein portion mapping mode comprises:
designating a portion of the display screen as a portion mapping area, the portion mapping area being less than the entire display screen area; and
mapping the absolute coordinates of the one or more finger touch points of the touch data to corresponding coordinates of the portion mapping area; and
mapping finger movements on the touch pad to the display screen according to the one or more mapping modes.

2. The method of claim 1, wherein a second mapping mode comprises entire mapping mode, wherein entire mapping mode comprises mapping the absolute coordinates of the one or more finger touch points of the touch data to coordinates of the entire display screen area.

3. The method of claim 2, further comprising switching between portion mapping mode and entire mapping mode when a touch state of the touch data is an initial touch state and when at least one of the following occurs: (i) the touch is held for a predetermined amount of time, (ii) the touch exceeds a threshold pressure, and (iii) a secondary touch pad is touched.

4. The method of claim 1, further comprising adjusting the location of the portion mapping area on the display screen if the touch data identifies only a single finger touch point and the coordinates of the finger touch point enters an edge region of the portion mapping area.

5. The method of claim 1, further comprising recognizing a trajectory of the one or more touch points over time, and identifying a two finger gesture based on the trajectory of the one or more touch points over time, and continuing the two finger gesture outside of the portion mapping area when one of the two finger touch points is within an edge region of the portion mapping area.

6. The method of claim 1, further comprising identifying a two finger stretch gesture when the touch data identifies the absolute coordinates of two finger touch points on the touch pad that are moving apart over time, and expanding the size of the portion mapping area when at least one of the touch points is within the edge region of the portion mapping area.

7. The method of claim 1, further comprising recognizing a trajectory of the one or more touch points over time, and generating at least one of a pinch and stretch gesture touch command message when the touch points are recognized as having diagonal trajectories.

8. The method of claim 1, further comprising recognizing a trajectory of the one or more touch points over time, and generating a rotation gesture touch command message when the touch points are recognized as having circular trajectories.

9. The method of claim 1, further comprising recognizing a trajectory of the one or more touch points over time, and generating a translating gesture touch command message when the touch points are recognized as having at least one of a horizontal and vertical trajectory.

10. The method of claim 1, further comprising identifying the resolution settings of a host PC change.

11. A method for mapping finger movements on a touch pad to a display screen, the method comprising:
receiving touch data from a primary touch pad, the touch data indicating the absolute coordinates of a first finger touch point on the primary touch pad;
receiving touch data from a secondary touch pad, the touch data indicating the touch status of the touch pad;
creating coordinates for a second, virtual touch point on the primary touch pad when the touch status of the secondary touch pad indicates that the secondary touch pad is touched; and
mapping the coordinates of the first finger touch point and the second, virtual finger touch point to the display screen.

12. The method of claim 11, further comprising providing one or more mapping modes for mapping the coordinates of first finger touch point and the second, virtual finger touch point to the display screen, wherein one mapping mode comprises a portion mapping mode and wherein portion mapping mode comprises:
designating a portion of the display screen as a portion mapping area, the portion mapping area being less than the entire display screen area; and
mapping the absolute coordinates of the one or more finger touch points of the touch data to corresponding coordinates of the portion mapping area.

13. The method of claim 12, wherein a second mapping mode comprises entire mapping mode, wherein entire mapping mode comprises mapping the absolute coordinates of the one or more finger touch points of the touch data to coordinates of the entire display screen area.

14. The method of claim 13, further comprising switching between portion mapping mode and entire mapping mode when a touch state of the touch data is an initial touch state and when at least one of the following occurs: (i) the touch is held for a predetermined amount of time, (ii) the touch exceeds a threshold pressure, and (iii) a secondary touch pad is touched.

15. The method of claim 12, further comprising adjusting the location of the portion mapping area on the display screen if the touch data identifies that the coordinates of the first finger touch point enters an edge region of the portion mapping area.

16. The method of claim 12, further comprising recognizing a trajectory of the first finger touch point over time, and identifying a two finger gesture from the trajectory of the first finger touch point over time, and continuing the two finger gesture outside of the portion mapping area when the coordinates of the first finger touch point enters within an edge region of the portion mapping area.

17. The method of claim 12, further comprising identifying a two finger stretch gesture when the touch data identifies the absolute coordinates of the first finger touch point move in a diagonal direction, and expanding the size of the portion mapping area when the first finger touch point enters an edge region of the portion mapping area during the stretch gesture.

18. The method of claim 12, further comprising recognizing a trajectory of the first finger touch point over time, and generating at least one of a pinch and stretch gesture touch command message when the first finger touch point is recognized as having a diagonal trajectory.

19. The method of claim 18, wherein a stretch gestures touch command message is generated when the first finger touch point is recognizes as having a diagonal trajectory and the angle of trajectory is 45° ±a predefined angle deviation value.

20. The method of claim 18, wherein a pinch gestures touch command message is generated when the first finger touch point is recognizes as having a diagonal trajectory and the angle of trajectory is approximately −135°±a predefined angle deviation value.

21. The method of claim 12, further comprising recognizing a trajectory of the first finger touch point over time, and generating a rotation gesture touch command message when the first finger touch point is recognized as having a circular trajectory.

22. The method of claim 12, further comprising recognizing a trajectory of the first finger touch point over time, and generating a translating gesture touch command message when the first finger touch point is recognized as having at least one of a horizontal and vertical trajectory.

23. The method of claim 12, further comprising identifying the trajectory of a first finger touch point by identifying a first touch point (x1, y1) and a second touch point (x2, y2) and by determining a trajectory angle by determining ArcTan((y2−y1)/(x2−x1)).

24. The method of claim 23, further comprising generating a rotation gesture touch command message when the trajectory angle of a continuous touch gesture changes over time, indicating a circular trajectory.
